(19) United States
(12) Patent Application Publication
(10) Pub. No.: US 2024/0193727 A1
(43) Pub. Date: Jun. 13, 2024

(54) METHOD AND APPARATUS WITH FRAME IMAGE RECONSTRUCTION

(71) Applicant: SAMSUNG ELECTRONICS CO., LTD., Suwon-si (KR)

(72) Inventors: Hyeonseung YU, Suwon-si (KR); Nahyup KANG, Suwon-si (KR); Hanjun KIM, Suwon-si (KR); Jaeyoung MOON, Suwon-si (KR); Juyoung LEE, Suwon-si (KR); Hwiryong JUNG, Suwon-si (KR); Inwoo HA, Suwon-si (KR); Seokpyo HONG, Suwon-si (KR)

(73) Assignee: SAMSUNG ELECTRONICS CO., LTD., Suwon-si (KR)

(21) Appl. No.: 18/332,939

(22) Filed: Jun. 12, 2023

(30) Foreign Application Priority Data
Dec. 9, 2022 (KR) 10-2022-0171259

(51) Int. Cl. G06T 3/40; G06T 3/00; G06T 7/50; G06T 7/90; G06V 10/764

(52) U.S. Cl. CPC G06T 3/4053; G06T 3/0093; G06T 7/50; G06T 7/90; G06V 10/764; G06T 2207/10024; G06V 2201/07

(57) ABSTRACT

A processor implemented method includes generating a semantic map indicating a visualization property assigned to an object of an obtained frame image having a first resolution and generating a reconstruction image using an image reconstruction machine learning model provided input based on the obtained frame image and the semantic map having a second resolution and including a second object having a visualization property indicated by the semantic map.

### CROSS-REFERENCE TO RELATED APPLICATIONS

This application claims the benefit under 35 USC § 119(a) of Korean Patent Application No. 10-2022-0171259, filed on Dec. 9, 2022, in the Korean Intellectual Property Office, the entire disclosure of which is incorporated herein by reference for all purposes.

### BACKGROUND

### 1 Field

The following description relates to a method and apparatus with frame image reconstruction.

### 2. Description of Related Art

Super sampling, an anti-aliasing technique, may correspond to a process of removing aliasing corresponding to edges of bumpy pixels. In one example, a neural super sampling technique based on a deep learning neural network may be used for anti-aliasing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating a semantic map indicating a visualization property assigned to a first object of an obtained frame image having a first resolution and generating a reconstruction image using an image reconstruction machine learning model provided input based on the obtained frame image and the semantic map, having a different second resolution and including a second object having a visualization property indicated by the semantic map.

The generating of the semantic map includes obtaining semantic data for the visualization property and generating, based on an object identifier map may include the obtained semantic data and regions classified by plural objects of the obtained frame image, a semantic map indicating a corresponding visualization property of a corresponding object of the plural objects through a region corresponding to each corresponding object.

The obtaining of the semantic data may include receiving a user input to assign, for the plural objects of the obtained frame image, a corresponding visualization property for one or more corresponding objects.

The generating of the semantic map may include generating a semantic map indicating one or more of a type, pattern, material, or shape of the first object.

The generating of the semantic map may include indicating rendering information including one or more of a color, a diffuse color, a depth, a normal line, a specular reflection, or an albedo of the obtained frame image together with the visualization property.

The generating of the semantic map may include indicating, for a plurality of objects in the obtained frame image, a visualization property for each object of the plurality of objects.

The image reconstruction machine learning model is a machine learning model trained using an objective function calculated based on a second visualization property of a third object of a temporary output image and a third visualization property indicated by a training semantic map together with a difference between a temporary output image and a true value output image obtained from a training input image and the training semantic map.

In the method, generating of the semantic map may include generating a current semantic map of a current frame image, as the obtained frame image, indicating a visualization property for an object of the current frame image, the method further may include obtaining a previous reconstruction image of a previous frame, and the input provided to the image reconstruction machine learning model is further based on the previous reconstruction image.

The generating of the semantic map may include generating a current semantic map of a current frame image, as the obtained frame image, indicating a visualization property for an object of the current frame image, the method further may include obtaining a previous reconstruction image of a previous frame, and the reconstructing of the current frame image into the reconstruction image of the current frame may include obtaining a warped image by warping the reconstruction image of the previous frame to the current frame based on a motion vector map between the current frame image and the reconstruction image of the previous frame and reconstructing the current frame image into the reconstruction image of the current frame by implementing a machine learning model provided input based on the obtained warped image together with the current frame image and the semantic map, and the input provided to the image reconstruction machine learning model is further based on the obtained warped image.

The reconstructing of the current frame image into the reconstruction image of the current frame includes generating a disocclusion map indicating whether a corresponding object is in a previous frame image through a region corresponding to each object of the current frame image and reconstructing the current frame image into the reconstruction image of the current frame based on a previous frame image being masked based on the generated disocclusion map.

The second resolution may be higher than the first resolution.

In a general aspect, here is an apparatus including a processor configured to generate a semantic map indicating a first visualization property assigned to a first object within a frame image having a first resolution and generate a reconstruction image, by using an image reconstruction machine learning model provided the frame image and the semantic map having a different second resolution and including a second object has a second visualization property indicated by the semantic map.

The processor may be further configured to obtain semantic data for the first visualization property and generate, based on an object identifier map may include the obtained semantic data and regions classified by plural objects within the frame image, a semantic map indicating a corresponding visualization property assigned to a corresponding object of the plural objects through a region corresponding to each object.

The processor may be further configured to obtain the semantic data by receiving, for each object of the frame image, an input visualization property based on a user input as the corresponding visualization property of the corresponding object.

The processor may be further configured to generate the semantic map to indicate one or more of a type, pattern, material, or shape of the first object, and a value of the second resolution is greater than a value of the first resolution.

The processor may be further configured to generate the semantic map to indicate rendering information including one or more of a color, a diffuse color, a depth, a normal line, a specular reflection, or an albedo of the frame image together with the first visualization property.

The processor may be further configured to apply an image reconstruction machine learning model is machine learning model trained using an objective function calculated based on a second visualization property of a third object of a temporary output image and a third visualization property indicated by a training semantic map together with a difference between a temporary output image obtained from a training input image and the training semantic map and a true value output image.

The processor may be further configured to generate a semantic map of a current frame image, as the frame image, indicating a current visualization property of an object of the current frame image and obtain a previous reconstruction image of a previous frame, the input provided to the image reconstruction machine learning model is further based on the previous reconstruction image.

The processor may be further configured to generate a semantic map of a current frame image, as the frame image, indicating a current visualization property of an object of the current frame image, obtain a previous reconstruction image of a previous frame, obtain a warped image by warping the reconstruction image of the previous frame to the current frame based on a motion vector map between the current frame image and the reconstruction image of the previous frame, and reconstruct the current frame image into the reconstruction image of the current frame by applying a machine learning model to the obtained warped image together with the current frame image and the semantic map, and the input provided to the image reconstruction machine learning model is further based on the obtained warped image.

The processor may be further configured to generate a disocclusion map indicating whether a corresponding object is in a previous frame image through a region corresponding to each object of the current frame image, the input provided to the image reconstruction machine learning model is further based on a masking of the previous frame image based on the generated disocclusion map.

In a general aspect, here is provided a processor-implemented method, the method including identifying objects within a frame image, generating a semantic map of the frame image, the semantic map including regions for corresponding objects, each object having a visualization property assigned thereto, and generating, using an image reconstruction machine learning model, a reconstruction image from the frame image and the semantic map, wherein in the first image has a first resolution, and wherein the reconstruction image has a second resolution greater than the first resolution.

Other features and aspects will be apparent from the following detailed description, the drawings, and the claims.

### BRIEF DESCRIPTION OF THE DRAWINGS

FIG. 1 illustrates an example electronic apparatus with image reconstruction according to one or more embodiments.

FIG. 2 illustrates an example method of reconstructing a frame image into a reconstruction image according to one or more embodiments.

FIG. 3 illustrates an example generation of a semantic map according to one or more embodiments.

FIG. 4 illustrates an example generated semantic map generated by an image reconstruction apparatus according to one or more embodiments.

FIG. 5 illustrates an example operation of reconstructing a frame image into a reconstruction image according to one or more embodiments.

FIG. 6 illustrates an example method of reconstructing a current frame image into a reconstruction image of a current frame based on a previous frame image according to one or more embodiments.

FIG. 7 illustrates an example method of reconstructing a current frame image into a reconstruction image of a current frame based on a reconstruction image of a previous image according to one or more embodiments.

FIG. 8 illustrates an example method of converting a rendered image into a photorealistic image based on a semantic map according to one or more embodiments.

Throughout the drawings and the detailed description, unless otherwise described or provided, it may be understood that the same drawing reference numerals refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

In an example, super sampling may be achieved in one or more image reconstruction techniques, which may include computer games or other programs that produce images, e.g., by gaming computer systems/apparatuses. In an example, such super sampling may include the smoothing of bumpy pixels.

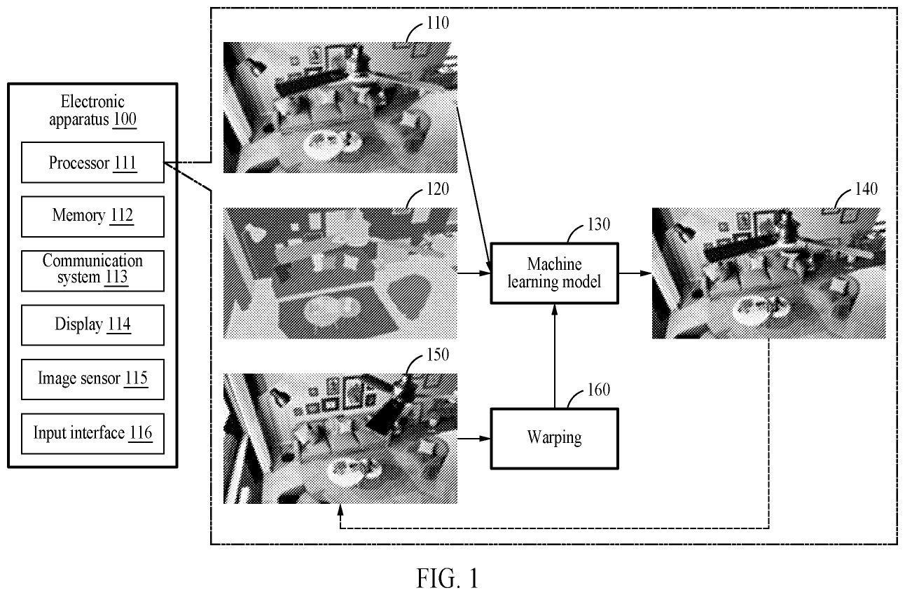

FIG. 1 illustrates an example of an electronic apparatus with image reconstruction according to one or more embodiments.

In a non-limiting example, an electronic apparatus 100 may reconstruct a frame image 110 into a reconstruction image 140 based on a semantic map 120. The semantic map 120 may indicate a visualization property assigned to an object (hereinafter, referred to as an “object of the frame image 110”) visible in the frame image 110. An object (hereinafter referred to as an “object of the reconstruction image 140”) visible in the reconstruction image 140 may have a visualization property indicated by the semantic map 120. A resolution of the reconstruction image 140 may be higher than that of the frame image 110.

In an example, the electronic apparatus 100 may obtain the frame image 110, where the first frame has, or is set to, a first resolution. The electronic apparatus 100 may generate the semantic map 120 for the object of the frame image 110. The electronic apparatus 100 may reconstruct the frame image 110 into the reconstruction image 140 set to a second resolution that is higher than the first resolution by implementing (e.g., executing) a machine learning model 130 provided (e.g., input) input based on the frame image 110 and the semantic map 120 (e.g., provided the machine learning model 130, semantic map 120, and frame image 110).

However, the image construction apparatus 100 is not limited to reconstructing the frame image 100 based on the frame image 110 of a single frame, and the image construction apparatus 100 may reconstruct the frame image 110 based on frame images from a plurality of frames.

In an example, the electronic apparatus 100 may obtain a current frame image of a current frame (e.g., an N-th frame image of an N-th frame). For example, in addition to a processor 111 and a memory 112, the electronic apparatus 100 may include an image sensor 15 that is configured to capture the image frames. The electronic apparatus 100 may generate a semantic map (e.g., an N-th semantic map of an N-th frame) for an object within the current frame image. The electronic apparatus 100 may obtain a previous frame image of a previous frame (e.g., an N−1-th frame image of an N−1-th frame). The electronic apparatus 100 may reconstruct the current frame image into a reconstruction image of the current frame further based on the previous frame image (e.g., the N−1-th frame image of the N−1-th frame and a reconstruction image of the N−1-th frame) together with the current frame image and the semantic map.

For example, the previous frame image of the previous frame may be a reconstruction image of the previous frame that is at the second resolution. When sequentially reconstructing a frame image of a frame, the electronic image 100 may be in a state in which reconstruction of the previous frame image into the reconstruction image of the previous frame is complete at a time of reconstructing the current frame image. The processor 111 may use the reconstruction image of the previous frame to reconstruct the current frame image.

In an example, the electronic apparatus 100 may further include a communication system 113, e.g., including wired and wireless hardware interfaces, such as respective transceivers.

The processor 111 may be configured to execute programs or applications to configure the processor 111 to control the electronic apparatus 100 to perform one or more or all operations and/or methods involving the reconstruction of images, and may include any one or a combination of two or more of, for example, a central processing unit (CPU), a graphic processing unit (GPU), a neural processing unit (NPU) and tensor processing units (TPUs), but is not limited to the above-described examples.

The memory 112 may include computer-readable instructions. The processor 111 may be configured to execute computer-readable instructions, such as those stored in the memory 112, and through execution of the computer-readable instructions, the processor 111 is configured to perform one or more, or any combination, of the operations and/or methods described herein. The memory 112 may be a volatile or nonvolatile memory.

In an example, the processor 111 may obtain the frame image 110, generate the semantic map 120 for the obtained frame image 110, and reconstruct the frame image 110 into the reconstruction image 140 based on the semantic map 120.

The memory 112, or another memory also represented by memory 112, may temporarily and/or permanently store at least one of a frame, the frame image 110, the semantic map 120, or the reconstruction image 140. The memory 112 may store instructions to obtain the frame image 110, instructions to generate the semantic map 120, and/or instructions to reconstruct the frame image 110 into the reconstruction image 140, and upon respective executions of such instructions the processor 111 is configured to perform and each respective operation. However, these are merely examples, and information stored in the memory 120 is not limited thereto.

The communication system 113 may transmit and receive at least one of the frame image 110 (e.g., the current frame image of the current frame and the previous frame image of the previous frame), the semantic map 120, or the reconstruction image 140. For example, the communication system 113 may establish a wired communication channel and/or a wireless communication channel with an external apparatus (e.g., another electronic apparatus and a server, or the image sensor 115 in an example where the image sensor 115 is exterior of the electronic apparatus 100), which may further include establishment of communication via a long-range communication network, such as cellular communication, short-range wireless communication, local area network (LAN) communication, Bluetooth™, wireless-fidelity (Wi-Fi) direct or infrared data association (IrDA), a legacy cellular network, a fourth generation (4G) and/or 5G network, next-generation communication, the internet, or a computer network (e.g., LAN or a wide area network (WAN)). In addition to the image sensor 115, the electronic apparatus 100 may further include a display 114, e.g., to display a reconstructed image.

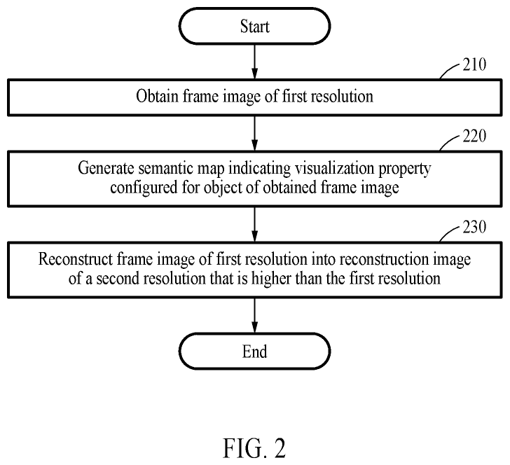

FIG. 2 illustrates an example of a method of reconstructing a frame image into a reconstruction image according to one or more embodiments.

An electronic apparatus (e.g., the electronic apparatus 100 of FIG. 1) may obtain a frame image, generate a semantic map for an object of the obtained frame image, and reconstruct the frame image into a reconstruction image based on the obtained frame image and the generated semantic map.

In operation 210, the electronic apparatus may obtain the frame image which is at a first resolution. The frame image may include one or more regions where each region corresponds to an object.

The frame image may include a region corresponding to an object visible in the frame image (or a frame of the frame image). Hereinafter, an object visible in a frame image may be referred to as an “object of a frame image,” and a region in which an object is visible in a frame image may be referred to as a “region corresponding to an object.”

The frame image, for example, may be an image obtained from a 3-dimensional (3D) scene (hereinafter, referred to as a “3D scene”) and an image corresponding to a frame for the 3D scene. A 3D scene may be a scene built by a 3D graphic tool and include an object placed in a 3D space of the 3D scene, such as where the electronic apparatus 100 is a gaming computer system, as a non-limiting example. The 3D graphic tool may include a hardware interface and a renderer, e.g., a process configured to perform rendering, or may be another operation performed by a processor of an electronic apparatus, such as processor 111 of the electronic apparatus 100 of FIG. 1. A frame may be determined by a viewpoint and/or a field of view (FOV) from which a 3D scene is viewed at a corresponding time point. A plurality of frame images based on a plurality of frames may be obtained from a single 3D scene.

In operation 220, the electronic apparatus may generate a semantic map for the frame image. The semantic map may indicate an object's visualization property within the frame image.

The semantic map may include a region corresponding to the object of the frame image. When a plurality of objects is visible in the frame image, the semantic map may include a region corresponding to each object. The semantic map may indicate a visualization property for an object within a region that corresponds to a particular object. For example, the semantic map may have a plurality of pixels. These pixels may have their own visualization property values. Thus, each object may have pixels that are included among the plurality of pixels of the semantic map. Accordingly, an object's pixels may have a visualization property value corresponding to that object.

Each object may have a first region and a second region. Thus, for each object, a first region corresponding to that object in the frame image may correspond to a second region corresponding to that object in an object semantic map. The placement of the first region in the frame image may be the same as the placement of the second region in the semantic map. The placement of a region may be a range occupied by a corresponding region in an image (or a map) and may, for example, include at least one of a position of the corresponding region in the image (or the map), a relative and/or absolute size of the region in the image (or the map), or a shape of the region.

A visualization property may be a property related to a visual representation of a region corresponding to each object within the frame image and may include a property that may be directly and/or indirectly used to visualize that object. For example, the visualization property may include at least one of a type property, a pattern property, a material property, and a shape property types, as non-limiting examples.

The type property included in the visualization property may be a visualization property representing a type of an object. Examples of the type property may include, for example, values corresponding to objects such as a floor, wall, sofa, carpet, or lamp types, as non-limiting examples. The type property types (object types) are not limited to the above-described examples and may include any other type of object.

The pattern property included in the visualization property may be a visualization property representing a design displayed on a surface of an object. Examples of the pattern property may include, for example, values corresponding to a wave pattern, wrinkle pattern, stripe pattern, dot pattern, check pattern, plain pattern (e.g., a pattern not containing repetition of a graphic object), or regular lines pattern types, as non-limiting examples. The pattern types are not limited to the above-described examples and may include any other type of pattern.

The material property included in the visualization property may be a visualization property representing a material of an object. Examples of materials may include, for example, values corresponding to wood, metal, fabric, plastic, glass, or stone types, as non-limiting examples. The material types are not limited to the above-described examples and may include any other type of material.

The shape property included in the visualization property may be a visualization property representing a shape of an object. Examples of the shape property may include, for example, values corresponding to a cube shape, cuboid shape, square shape, rectangular shape, rhombus shape, triangle shape, heart shape, or flat shape types, as non-limiting examples. The shape types are not limited to the above-described examples and may include any other type of shape.

Indeed, the examples of visualization properties for the semantic map discussed above are not limited to the above-described examples, and the semantic map may indicate a visualization property different from the above-described visualization properties according to a design and may have a more sub-values than the above-described examples as a value of a visualization property. For example, when the pattern property included in the visualization property is a dot pattern, the pattern property may have additional, sub-values corresponding to additional properties for the dot pattern, for example, one or more values including, for example, a size of a dot, spacing between dots, and a placement of dots. When a first object and a second object both having a dot pattern have a first dot pattern and a second dot pattern, respectively, the first and second dot patterns may be considered different sub-values for different dot patterns, and the semantic map may indicate patterns for the first object and the second object, such that the patterns are different from each other.

The semantic map may indicate each object's visualization property. Each object's visualization property may be assigned or otherwise determined based on the properties of that object. The semantic map may indicate the visualization property values that were assigned for each object by distinguishing one visualization property from another visualization property assigned to another object. For example, when the plurality of objects is visible in the frame image, a visualization property may be assigned for each of the plurality of objects. The semantic map may indicate visualization properties assigned for objects based on respective regions corresponding to each object of the frame image.

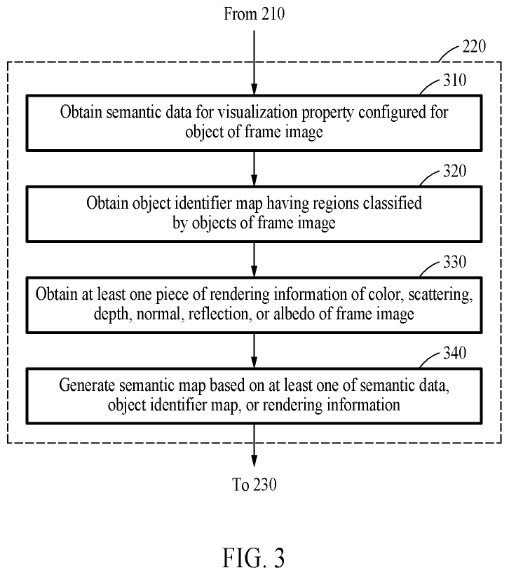

An image analysis apparatus may obtain semantic data on an assigned visualization property for an object of the frame image. The image analysis apparatus may obtain an object identifier map having regions classified by objects of the frame image. The image analysis apparatus may generate the semantic map based on the semantic data and the object identifier map. The generation of the semantic map based on the semantic data and the object identifier map is described in greater detail below with reference to FIG. 3.

In operation 230, the electronic apparatus may reconstruct the frame image having the first resolution into the reconstruction image having a second resolution where a value of the second resolution is higher than a value of the first resolution. An object of the reconstruction image may have a visualization property that is represented by the semantic map.

The reconstruction image may have a region corresponding to the object. The region corresponding to the object may include a region in which the object is visible in the reconstruction image. The object within the reconstruction image may have a visualization property where the visualization property may indicate that the region includes a graphic representation corresponding to the visualization property. When the semantic map indicates visualization properties such as type (e.g., a sofa), pattern (e.g., a wrinkle pattern), and material (e.g., fabric) visualization properties for an object, a region corresponding to the object in the reconstruction image may include a graphic representation corresponding to a fabric sofa with a wrinkle pattern.

The electronic apparatus may reconstruct the frame image into the reconstruction image by implementing a machine learning model provided input based on the obtained frame image and the generated semantic map. The machine learning model may include a machine learning model trained to output the reconstruction image by being applied to the frame image and the semantic map. The machine learning model may be trained to output the reconstruction image having the second resolution based on the frame image of the first resolution. The machine learning model may be trained to output the reconstruction image based on an object having a visualization property indicated by the semantic map. The machine learning model may be trained to output the reconstruction image where each object of the reconstruction image includes a graphic representation corresponding to the corresponding object's visualization property.

Some of the machine learning model may be trained using an objective function calculated based on training data.

In a non-limiting example, the training data may be a dataset including a plurality of training pairs. For example, a training pair may include a training input and a training output. The training output may be a value that is output from the training input, where the training input and training output forms a pair. The training data may include a plurality of training inputs and a training output mapped to each of the plurality of inputs.

The objective function may be a function that is defined to measure a degree to which weights of a currently set machine learning model are close to an optimum. The machine learning model may be trained by repeatedly changing a weight of the machine learning model based on a value of the objective function. For example, the objective function may be a loss function to calculate a loss between a temporary output, where the temporary output is actually output by the machine learning model based on the training input of the training data, and an expected value (e.g., a training output) to be output. The weights of the machine learning model may be updated such that a value of the loss function is reduced.

The training input may include an input image of the first resolution and a training semantic map. The training output may include a true value output image of the second resolution. The training semantic map may correspond to the training input image and indicate a visualization property configured for an object of a corresponding training input image.

The objective function may be calculated based on a difference between a temporary output image, the output image being obtained from the training input image and the training semantic map, and the true value output image. The temporary output image may be an image that is output by implementing a temporary machine learning model provided the training input image and the training semantic map. The temporary machine learning model may be a machine learning model of which training is yet to be completed, and the temporary machine learning model of which training is completed may be obtained as a machine learning model.

The objective function may be further calculated based on a visualization property of an object of the temporary output image and the visualization property indicated by the training semantic map together with a difference between the temporary output image and the true value output image.

For example, the objective function may include a value calculated for each object. The value calculated for each object may include a value related to the object of the temporary output image having the visualization property indicated by the training semantic map for the object. For each object of the training input image, the objective function may include a value calculated for a corresponding object based on a difference between a visualization property that the object has in the temporary output image and the visualization property indicated by the training semantic map for the object. The value calculated by the objective function for each object may be calculated based on a value corresponding to each visualization property of a corresponding object. The value corresponding to each visualization property of the corresponding object may include a value related to the corresponding object of the temporary output image having the visualization property indicated by the training semantic map for the corresponding object. For example, when the object has visualization properties such as a type (e.g., a sofa), a pattern (e.g., a wrinkle pattern), and a material (e.g., fabric) of the training input image, the training semantic map may calculate a value for the object by repeatedly calculating a value corresponding to each of these visualization properties (e.g., type, pattern, material) for the object.

For example, the objective function (loss) for training of the machine learning model may be expressed as below.

$$loss = {loss}_{img} + {\sum }_{obj} {loss}_{obj} \qquad Equation 1$$

Here, loss_{img} may denote a value calculated based on the difference between the temporary output image and the training output image, Σ_{obj} loss_{obj} may denote a value calculated based on the visualization property of the object of the temporary output image and the visualization property indicated by the training semantic map, and loss_{obj} may denote a value calculated for each object of the training input image.

FIG. 3 illustrates an example of a generation of a semantic map according to one or more embodiments.

In operation 310, an electronic apparatus may obtain semantic data for a visualization property configured for an object of a frame image. The semantic data may include a visualization property assigned or generated for each object of the frame image. For example, the semantic data may include an identifier of the object of the frame image and a visualization property (or a value indicating a visualization property) mapped to the identifier of the object.

The electronic apparatus may obtain the semantic data by assigning, for each object of the frame image, a visualization property that is determined based on a user input as a visualization property for the corresponding object. For example, a user input may be received (e.g., by an input interface 116 of the electronic apparatus 100 of FIG. 1) that assigns one or more visualization properties of a corresponding object. The user input may be received multiple times so that each object of the frame image has an assigned visualization property. Thus, the visualization property may be determined based on the user input and the visualization property of the corresponding object may be set. The example input interface may include a keyboard, mouse, touch pad/screen, microphone, etc. However, in some examples, a visualization property of an object does not require a user input, and the visualization property may be instead determined by a determination performed by the electronic apparatus and/or another electronic apparatus. For example, a visualization property may be determined in advance as a default value and/or a randomly determined visualization property may be assigned as the visualization property for the object, and/or a visualization property determined based on a visualization property determination model may be set as the visualization property of the object.

In an example, where the frame image is an image obtained from a 3D scene, the semantic data may be obtained from the 3D scene. The 3D scene may include a visualization property assigned to a placed object and/or each object. For one 3D scene, when a plurality of frame images based on a plurality of frames is obtained, a semantic map for each of the frame images may be generated. When the semantic data is obtained from the 3D scene, common semantic data (e.g., semantic data obtained from the 3D scene) may be used to generate a plurality of semantic maps for the plurality of frame images.

In operation 320, the electronic apparatus may obtain an object identifier map having regions classified by objects within the frame image.

The object identifier map may include a region corresponding to each object of the frame image. Each region of the object identifier map that corresponds to an object within the frame image may indicate an identifier of a corresponding object. For example, the object identifier map may include a plurality of pixels. Each of the objects within the frame may be within a corresponding region including a plurality of pixels for that object within an object identifier map and each pixel in that region may have a value which includes an identifier of that object.

For each object, a first region corresponding to an object in the frame image may correspond to a second region corresponding to that same object in the object identifier map. For example, a placement of the first region in the frame image may be the same as a placement of the second region in the object identifier map. For example, placement of a region may be a range occupied by a corresponding region in an image (or a map) and may, for example, include at least one of a position, size, or shape of the corresponding region.

Although an identifier assigned for each object to identify an object in an image (or a map) and a visualization property assigned for each object are described herein, examples are not limited thereto. An object may include a plurality of components, and the identifier may be assigned for each object and/or component, and a visualization property may be assigned for each object and/or component. For example, an object (e.g., a desk) may include a first component (e.g., an upper plate) and a second component (e.g., a leg), a visualization property (e.g., wood) that is assigned for the first component may have a different value that is independent from a visualization property (e.g., metal) assigned to the second component. That is, each element (e.g., a first and second component) of an object may have different visualization properties. For an object that includes a large number of components and/or having components that has some or all of its visualization properties be significantly different from each other, the electronic apparatus may reconstruct the frame image into a reconstruction image having details using a visualization property assigned for each component.

In operation 330, the electronic apparatus may obtain rendering information of the frame image. The rendering information may be information about a geometric property of the frame image and include at least one of a color, diffuse color, depth, normal line, specular reflection, or albedo.

For each of a plurality of objects, the rendering information may include rendering information for a corresponding object of those objects. For example, the rendering information may include an identifier of each object and rendering information (or a value indicating rendering information) for each object. Herein, rendering may include information rendering information for each object has been described, but examples are not limited thereto, and rendering information may include common rendering information for an entire frame image.

In operation 340, the electronic apparatus may generate the semantic map based on one or more of the semantic data, the object identifier map, or the rendering information.

The electronic apparatus may generate the semantic map indicating a visualization property assigned to a corresponding object for regions corresponding to each object based on the semantic data and the object identifier map.

The electronic apparatus may generate the semantic map by combining a visualization property indicated by the semantic data and the object identifier map using the object identifier. For example, the electronic apparatus may generate, by combining the regions corresponding to each object in the object identifier map with a visualization property assigned to a corresponding object, the semantic map indicating a visualization property through a region corresponding to the corresponding object. For example, the electronic apparatus may obtain the identifier of the corresponding object in the region corresponding to each object in the object identifier map. The electronic apparatus may obtain the visualization property for the corresponding object from the semantic data based on the identifier of the corresponding object. The electronic apparatus may combine the visualization property for the corresponding object with the region corresponding to each object of the object identifier map.

The electronic apparatus may generate the semantic map further based on the rendering information together with the semantic data and the object identifier map. The electronic apparatus may generate the semantic map further indicating the rendering information of the frame image together with a visualization property that was assigned for an object.

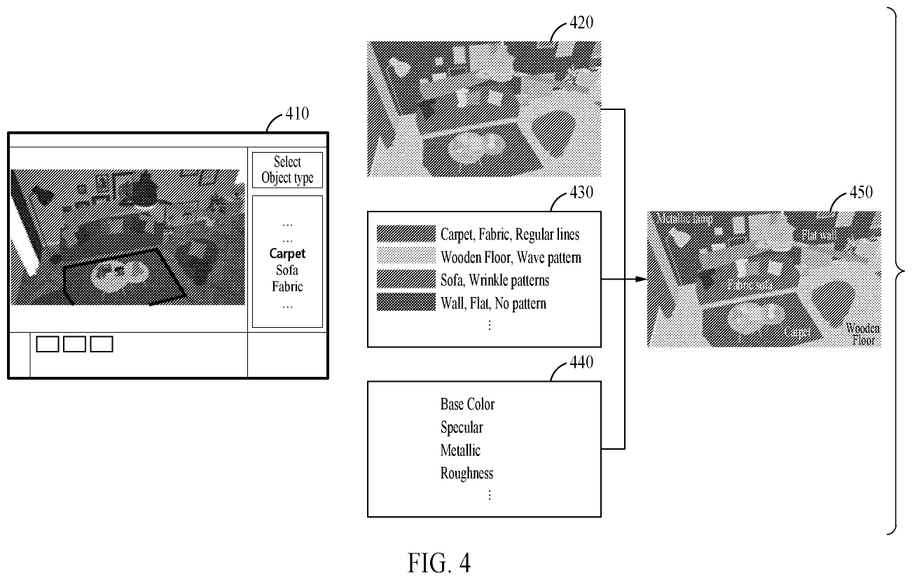

FIG. 4 illustrates an example of a generated semantic map according to one or more embodiments.

In a non-limiting example, an electronic apparatus may generate a semantic map 450 of a frame image obtained from a 3D scene built by a 3D graphic tool 410. For example, an object identifier map 420, semantic data 430, and rendering information 440 may be obtained based on information about an object placed in the 3D scene.

The object identifier map 420 may include a region corresponding to each object within the frame image. The object identifier map 420 may indicate an identifier of a corresponding object through a region corresponding to each object.

The semantic data 430 may be determined based on a user input. For example, an interface (hereinafter, referred to as a “visualization property configuration interface”) for setting, assigning, or otherwise generating a visualization property may be provided to a user in the 3D graphic tool 410. The visualization property configuration interface may be an interface for assigning a visualization property of a corresponding object for each object placed in the 3D scene. The visualization property of each object may be determined based on the user input obtained through the visualization property configuration interface. The semantic data 430 may map the determined visualization property of each object to an identifier of a corresponding object and store it.

The rendering information 440 may include an identifier of an object of the frame image and rendering information mapped to the identifier. The rendering information 440 may map rendering information for each object to an identifier of a corresponding object and store it.

The electronic apparatus may generate the semantic map 450 based on the object identifier map 420, the semantic data 430, and the rendering information 440. The semantic map 450 may indicate a visualization property configured for a corresponding object and rendering information for the corresponding object through a region corresponding to each object.

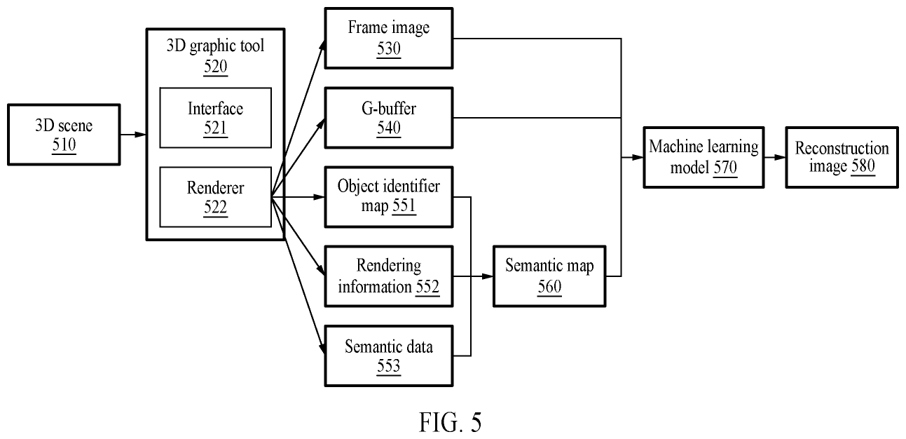

FIG. 5 illustrates an example operation of reconstructing a frame image into a reconstruction image according to one or more embodiments.

In a non-limiting example, a 3D scene 510 may be input to a 3D graphic tool 520. The 3D graphic tool 520 may include an interface 521 and a renderer 522.

The interface 521 may be an interface for configuring a visualization property for an object placed in the 3D scene and may include an interface for obtaining a user input for assigning the visualization property for the object. Semantic data 553 may be obtained based on the user input obtained through the interface 521, which will be described later.

The renderer 522 may render at least one of a frame image 540, a geometry (G)-buffer 540, an object identifier map 551, rendering information 552, or the semantic data 553 based on the 3D scene 510.

The frame image 530 may include a planar image (e.g., a 2D image) obtained based on a frame from the 3D scene 510.

The G-buffer 540 may include rendering information for the frame (or the frame image 530). For example, the G-buffer 540 may include rendering information for the entire frame image, the rendering information being different from rendering information for each object of the frame image.

The object identifier map 551 may indicate an identifier of each object for the frame (or the frame image 530). For example, the 3D graphic tool 520 may receive an identifier of an object placed together with the 3D scene, and the renderer 522 of the 3D graphic tool 520 may generate the object identifier map 551 indicating an identifier of a corresponding object through a region corresponding to each object of the frame image 530.

The rendering information 552 may include the rendering information for each object for the frame (or the frame image 530). For example, the rendering information 552 may store the rendering information for each object together with an identifier of a corresponding object.

The semantic data 553 may include a visualization property for each object. The visualization property for each object may be determined based on a user input obtained through the interface 521. For example, the semantic data 553 may store the visualization property for each object together with an identifier of a corresponding object.

The semantic map 560 may be generated based on the object identifier map 551, the rendering information 552, and the semantic data 553. The semantic map 560 may be data indicating a visualization property for the frame (or the frame image 530) and may indicate a visualization property assigned to a corresponding object through the region corresponding to each object.

A machine learning model 570 may output a reconstruction image 580 by being applied to at least one of the frame image 530, the G-buffer 540, the object identifier map 551, the rendering information 552, or the semantic data 553. The machine learning model 570 may include a machine learning model trained to output the reconstruction image 580. For example, the machine learning model 570 may include the machine learning model trained to output the reconstruction image 580 of a resolution (e.g., a second resolution) higher than a resolution (e.g., a first resolution) of the frame image 530. The machine learning model 570 may include the machine learning model trained to output the reconstruction image 580 having a visualization property, which is set for a corresponding object and indicated by the semantic map 560, in the region corresponding to each object of the frame image 530.

The reconstruction image 580 may be an image of a resolution (e.g., the second resolution) higher than the resolution (e.g., the first resolution) of the frame image 530. The reconstruction image 580 may have the visualization property, which is configured for each object and indicated by the semantic map 560, in the region corresponding to each object of the frame image 530. That is, in an example, the reconstruction image 580 is a complete, high-resolution image based on the desired features for the image that was input through the interface 521 of the 3D graphic tool 520.

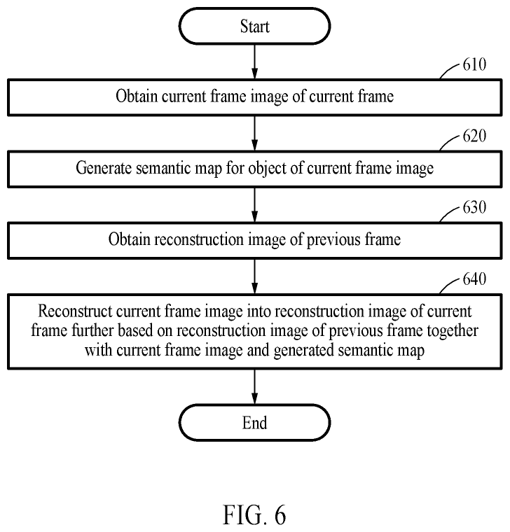

FIG. 6 illustrates an example method of reconstructing a current frame image into a reconstruction image of a current frame based on a previous frame image according to one or more embodiments.

In a non-limiting example, in operation 610, an image analysis apparatus may obtain a current frame image (e.g., the frame image of FIG. 2) of a current frame. The current frame image may be an image of a first resolution.

The image analysis apparatus may obtain a plurality of frame images of a plurality of frames. The plurality of frame images may be images of the first resolution. For example, the plurality of frame images may be images obtained from an identical 3D scene according to a frame change. The image analysis apparatus may reconstruct the plurality of frame images of the plurality of frames in an order of the frames. Among the plurality of frame images of the plurality of frames, a frame image of a frame being reconstructed by the image analysis apparatus may be represented as the “current frame image of the current frame.”

In operation 620, the image analysis apparatus may generate a semantic map of the current frame. The semantic map of the current frame may indicate a visualization property for an object of the current frame image. As described above with reference to FIG. 2, the electronic apparatus may generate a visualization map for a corresponding object through regions corresponding to each object within the current frame image. The semantic map of the current frame may indicate a visualization property for each object of the current frame image.

The semantic map of the current frame may be generated based on at least one of semantic data, an object identifier map, or rendering information.

The semantic data may be common to the plurality of frames (e.g., a current frame and a previous frame). However, examples are not limited thereto, and the semantic data may include a plurality of pieces of independent semantic data for each of the plurality of frames, and the semantic map of the current frame may be based on the semantic map for the current frame.

The object identifier map may include an independent object identifier map for each of the plurality of frames. For example, the object identifier map may be changed according to a frame change, and an object identifier map of each frame may indicate an identifier of an object through a region corresponding to an object visible in a corresponding frame. The semantic map of the current frame may be generated based on the object identifier map of the current frame.

The rendering information may include a plurality of pieces of rendering information for the plurality of frames. For example, the rendering information may be changed according to the frame change, and rendering information of each frame may indicate rendering information for an object of a corresponding frame. However, as described above with reference to FIG. 3, the rendering information is not limited to including rendering information for each object, and the rendering information may include rendering information common to an entire frame image. The semantic map of the current frame may be generated based on the rendering information of the current frame.

In operation 630, the image analysis apparatus may obtain a reconstruction image of a previous frame. The reconstruction image of the previous frame may be obtained by reconstructing a previous frame image of the previous frame of a first resolution into the reconstruction image of the previous frame of a second resolution.

As described above, the image analysis apparatus may reconstruct the plurality of frame images of the plurality of frames in an order of the frames. At a time when reconstruction of the current frame image is performed, the reconstruction of the previous frame image of the previous frame of the current frame may have already been performed, and the reconstruction image of the previous frame that is already reconstructed may be used to reconstruct the current frame image.

In operation 640, the image analysis apparatus may reconstruct the current frame image into a reconstruction image of the current frame further based on the reconstruction image of the previous frame together with the current frame image and the semantic map of the current frame.

The image analysis apparatus may reconstruct the current frame image into the reconstruction image of the current frame by further implementing a machine learning model provided input based on the reconstruction image of the previous frame together with the current frame image and the semantic map of the current frame. As described above with reference to FIG. 2, the machine learning model may be trained to output a reconstruction image having a second resolution value that is higher than a value of the first resolution. The machine learning model may be trained to output the reconstruction image of which an object has a visualization property indicated by the semantic map.

In an example, the electronic apparatus may reconstruct the current frame image into the reconstruction image of the current frame based on a motion vector map between the current frame image and the previous frame image.

The reconstruction image of the previous frame may be warped to the current frame in response to applying the motion vector map from the previous frame to the current frame.

“Warping” may include forward warping, which maps a corresponding point of an input image to a target image using the motion vector map, and backward warping in which the input image is mapped and imported using the motion vector map at the corresponding point of the target image. Hereinafter, the term “warp/warping” may be understood to have the meaning of backward warping even though there is no separate description.

In an example, the “motion vector map” may represent a matching relationship between first pixels of the current frame and second pixels of the previous frame. The “matching relationship” may be understood to indicate which second pixels match the first pixels and to include a distance and a direction between pixels that match each other. A motion vector map representing a distance and a direction from pixels of the current frame to matching pixels of the previous frame may be referred to as a “backward motion vector map,” and a motion vector map representing a distance and a direction from the pixels of the previous frame to matching pixels of the current frame may be referred to as a “forward motion vector map.” Hereinafter, the term “motion vector map” may be understood to have the meaning of a backward motion vector map even though there is no separate description. For example, the motion vector map may be generated by a renderer (e.g., the renderer 522 of FIG. 5) of a 3D graphic tool (e.g., the 3D graphic tool 520 of FIG. 5) based on a 3D scene (e.g., the 3D scene 510 of FIG. 5).

For example, the electronic apparatus may obtain a warped image of the current frame by warping the reconstruction image of the previous frame to the current frame based on the motion vector map between the current frame image and the previous frame image. The electronic apparatus may reconstruct the current frame image into the reconstruction image of the current frame by implementing the machine learning model provided input based on the warped image that is warped to the current frame together with the current frame image and the semantic map of the current frame.

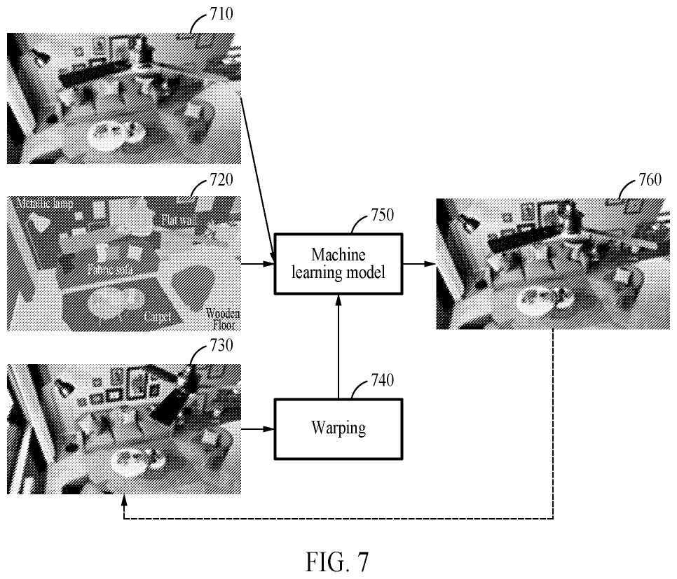

The electronic apparatus may also reconstruct the current frame image into the reconstruction image of the current frame based on a disocclusion map together with the motion vector map. The reconstruction of the current frame image based on the disocclusion map is described later with reference to FIG. 7.

FIG. 7 illustrates an example method of reconstructing a current frame image into a reconstruction image of a current frame based on a reconstruction image of a previous image according to one or more embodiments.

In a non-limiting example, an image analysis apparatus may obtain a current frame image 710 of a current frame (e.g., an N-th frame). The image analysis apparatus may generate a semantic map 720 of the current frame (e.g., the N-th frame). The image analysis apparatus may obtain a reconstruction image 730 of a previous frame (e.g., an N−1-th frame). The image analysis apparatus may obtain a warped image (not shown) by warping the reconstruction image 730 of the previous frame. The image analysis apparatus may reconstruct the current frame image 710 into a reconstruction image 760 of the current frame by implementing a machine learning model 750 provided input based on the current frame image 710, the semantic map 720 of the current frame, and the warped image.

However, the image analysis apparatus is not limited to reconstructing the current frame image 710 based on at least one of the current frame image 710, the semantic map of the current frame, or the warped image (not shown). The image analysis apparatus may reconstruct the current frame image 710 based on the disocclusion map. The image analysis apparatus may mask the warped image based on the disocclusion map and reconstruct the current frame image 710 into the reconstruction image 760 of the current frame based on the masked warped image.

The disocclusion map may indicate whether disocclusion occurs in a region. For example, disocclusion may refer to a situation where at least a portion of an object that is occluded (e.g., invisible) by another object in a previous frame is now visible in a current frame according to a frame change when pixels of the current frame and pixels of the previous pixels match, and a disocclusion region may include a region corresponding to at least a portion of the object that was occluded in the previous frame and is now visible in the current frame.

The disocclusion map may be generated by comparing the previous frame image and the current frame image. For example, the disocclusion map may be generated based on at least one of a motion vector map, a depth map of the previous frame and the current frame, or an object identifier map. The depth map may be a map indicating a depth value corresponding to each pixel of a frame image and may be generated by, for example, a renderer (e.g., the renderer 522 of FIG. 5).

In an example, the image analysis apparatus may mask the warped image based on the disocclusion map. For example, the image analysis apparatus may mask a region corresponding to a disocclusion region in the warped image based on the disocclusion map. The image analysis apparatus may limit use of a region occluded in the warped image in the previous frame image by reconstructing the current frame image based on the masked warped image. For example, the image analysis apparatus may mask the region corresponding to the disocclusion region in the warped image and obtain the masked warped image by replacing the masked region with a partial image of the frame image (e.g., the current frame image).

The image analysis apparatus may reconstruct the current frame image 710 into the reconstruction image 760 of the current frame by implementing the machine learning model 750 provided input based on the masked warped image based on the current frame image 710, the semantic map 720 of the current frame, and the disocclusion map.

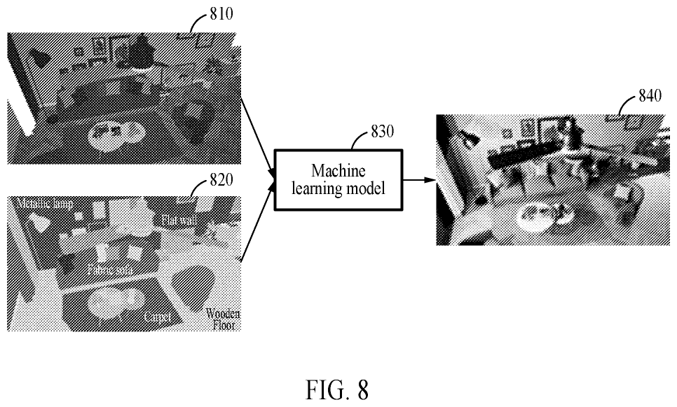

FIG. 8 illustrates an example method of converting a rendered image into a photorealistic image based on a semantic map according to one or more embodiments.

An image analysis apparatus may obtain a rendered image. The rendered image may include a region (e.g., a region where an object is visible) corresponding to an object.

The rendered image may include an image in which a 3D scene is rendered for a frame by a renderer (e.g., the renderer 522 of FIG. 5). The rendered image may be less photorealistic than a photorealistic image, which will be described in greater detail below.

In a non-limiting example, the image analysis apparatus may generate a semantic map 820 for the rendered image 810. The image analysis apparatus may generate the semantic map for the rendered image 810 based on at least one of an object identifier map (not shown) of the rendered image 810, semantic data (not shown), or rendering information (not shown). The semantic map 820 for the rendered image 810 may indicate a visualization property configured for a corresponding object through a region corresponding to each object of the rendered image. The generation of the semantic map 820 for the rendered image 810 may be generated based on all or some of the operations described above with reference to FIGS. 1 to 7.

The image analysis apparatus may convert a rendered image 810 into a photorealistic image 840 by implementing a machine learning model 830 provided input based on the rendered image 810 and the semantic map 820. The photorealistic image 840 may include a region corresponding to a corresponding object including a visualization property indicated by the semantic map 820 for each object of the rendered image 810. The photorealistic image 840 may be an image of a frame that is identical to a frame of the rendered image 810 and include a graphic representation that is more photorealistic than a graphic representation in the rendered image 810. The machine learning model 830 may include a machine learning model trained to output the photorealistic image 840 based on the rendered image 810 and the semantic map 820 of the rendered image 810.

The neural networks, processors, memories, communication systems, electronic apparatus 100, processor 111, memory 112, communication system 113, machine learning model 140, 3D graphic tool 520, interface 521, renderer 522, G-buffer 540, machine learning model 570 described herein and disclosed herein described with respect to FIGS. 1-8 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter.

The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating a semantic map indicating a visualization property assigned to a first object of an obtained frame image having a first resolution; and
generating a reconstruction image using an image reconstruction machine learning model provided input based on the obtained frame image and the semantic map, having a different second resolution and including a second object having a visualization property indicated by the semantic map.

2. The method of claim 1, wherein the generating of the semantic map comprises:
obtaining semantic data for the visualization property; and
generating, based on an object identifier map comprising the obtained semantic data and regions classified by plural objects of the obtained frame image, a semantic map indicating a corresponding visualization property of a corresponding object of the plural objects through a region corresponding to each corresponding object.

3. The method of claim 2, wherein the obtaining of the semantic data comprises receiving a user input to assign, for the plural objects of the obtained frame image, a corresponding visualization property for one or more corresponding objects.

4. The method of claim 1, wherein the generating of the semantic map comprises generating a semantic map indicating one or more of a type, pattern, material, or shape of the first object.

5. The method of claim 1, wherein the generating of the semantic map comprises indicating rendering information including one or more of a color, a diffuse color, a depth, a normal line, a specular reflection, or an albedo of the obtained frame image together with the visualization property.

6. The method of claim 1, wherein the generating of the semantic map comprises indicating, for a plurality of objects in the obtained frame image, a visualization property for each object of the plurality of objects.

7. The method of claim 1, wherein the image reconstruction machine learning model is a machine learning model trained using an objective function calculated based on a second visualization property of a third object of a temporary output image and a third visualization property indicated by a training semantic map together with a difference between a temporary output image and a true value output image obtained from a training input image and the training semantic map.

8. The method of claim 1, wherein the generating of the semantic map comprises generating a current semantic map of a current frame image, as the obtained frame image, indicating a visualization property for an object of the current frame image,
wherein the method further comprises obtaining a previous reconstruction image of a previous frame, and
wherein the input provided to the image reconstruction machine learning model is further based on the previous reconstruction image.

9. The method of claim 1, wherein the generating of the semantic map comprises generating a current semantic map of a current frame image, as the obtained frame image, indicating a visualization property for an object of the current frame image,
wherein the method further comprises obtaining a previous reconstruction image of a previous frame, and
wherein the reconstructing of the current frame image into the reconstruction image of the current frame comprises:
obtaining a warped image by warping the reconstruction image of the previous frame to the current frame based on a motion vector map between the current frame image and the reconstruction image of the previous frame; and
reconstructing the current frame image into the reconstruction image of the current frame by implementing a machine learning model provided input based on the obtained warped image together with the current frame image and the semantic map,
wherein the input provided to the image reconstruction machine learning model is further based on the obtained warped image.

10. The method of claim 8, wherein the reconstructing of the current frame image into the reconstruction image of the current frame comprises:
generating a disocclusion map indicating whether a corresponding object is in a previous frame image through a region corresponding to each object of the current frame image; and
reconstructing the current frame image into the reconstruction image of the current frame based on a previous frame image being masked based on the generated disocclusion map.

11. The method of claim 1, wherein the second resolution is higher than the first resolution.

12. An apparatus, comprising:
a processor configured to:
generate a semantic map indicating a first visualization property assigned to a first object within a frame image having a first resolution; and
generating a reconstruction image, by using an image reconstruction machine learning model provided the frame image and the semantic map having a different second resolution and including a second object having a second visualization property indicated by the semantic map.

13. The apparatus of claim 12, wherein the processor is further configured to:
obtain semantic data for the first visualization property; and
generate, based on an object identifier map comprising the obtained semantic data and regions classified by plural objects within the frame image, a semantic map indicating a corresponding visualization property assigned to a corresponding object of the plural objects through a region corresponding to each object.

14. The apparatus of claim 13, wherein the processor is further configured to obtain the semantic data by receiving, for each object of the frame image, an input visualization property based on a user input as the corresponding visualization property of the corresponding object.

15. The apparatus of claim 12, wherein the processor is further configured to generate the semantic map to indicate one or more of a type, pattern, material, or shape of the first object, and
wherein a value of the second resolution is greater than a value of the first resolution.

16. The apparatus of claim 12, wherein the processor is further configured to generate the semantic map to indicate rendering information including one or more of a color, a diffuse color, a depth, a normal line, a specular reflection, or an albedo of the frame image together with the first visualization property.

17. The apparatus of claim 12, wherein the image reconstruction machine learning model is machine learning model trained using an objective function calculated based on a second visualization property of a third object of a temporary output image and a third visualization property indicated by a training semantic map together with a difference between a temporary output image obtained from a training input image and the training semantic map and a true value output image.

18. The apparatus of claim 12, wherein the processor is further configured to:
generate a semantic map of a current frame image, as the frame image, indicating a current visualization property of an object of the current frame image; and
obtain a previous reconstruction image of a previous frame,
wherein the input provided to the image reconstruction machine learning model is further based on the previous reconstruction image.

19. The apparatus of claim 18, wherein the processor is further configured to:
generate a disocclusion map indicating whether a corresponding object is in a previous frame image through a region corresponding to each object of the current frame image,
wherein the input provided to the image reconstruction machine learning model is further based on a masking of the previous frame image based on the generated disocclusion map.

20. A processor-implemented method, the method comprising:
identifying objects within a frame image;
generating a semantic map of the frame image, the semantic map including regions for corresponding objects, each object having a visualization property assigned thereto; and
generating, using an image reconstruction machine learning model, a reconstruction image from the frame image and the semantic map, wherein the frame image has a first resolution, and wherein the reconstruction image has a second resolution greater than the first resolution.
